(19) United States
(12) Patent Application Publication
(10) Pub. No.: US 2005/0224543 A1
(43) Pub. Date: Oct. 13, 2005

(54) Vehicle rooftop mounted advertising device

(76) Inventor: Peter Cope, St. Ives (AU)

Correspondence Address: JOHN ALEXANDER GALBREATH, 2516 CHESTNUT WOODS CT, REISTERSTOWN, MD, 21136, US

(21) Appl. No.: 10/520,910

(22) PCT Filed: May 29, 2003
(86) PCT No.: PCT/AU03/00650

§ 371 Date: Jan. 10, 2005

(30) Foreign Application Priority Data
Jul. 11, 2002 (AU) 2002 95 0171

(51) Int. Cl. B60R 9/055

(52) U.S. Cl. 224/328

(57) ABSTRACT

A rooftop mounted advertising device (6) for a motor vehicle comprises of a luggage compartment (1, 3) having the capacity to contain at least a baby seat measuring in excess of 500 mm by 250 mm by 300 mm. Advertising display panels incorporated in the advertising device (6) have a substantial vertical profile when viewed from either side or the rear of the device. Illumination means for the advertising display panels (6) are protected from impact with articles in the luggage compartment (1, 6). An access door is adapted to provide ready access to the luggage compartment (1, 6) without its removal from its rooftop position.

The present invention relates to an advertising device for use atop motor vehicles and in particular to a rooftop mounted advertising display device having luggage carrying capacity adequate to contain at least a child safety seat.

For a number of years the taxi industry has been exploiting the additional revenue available through display of advertising material on the external surfaces of taxis and upon devices attached to the external panels of taxis designed to increase the surface area or visibility of such advertising. To date the most popular display device for this purpose is a thermoplastic moulding attached to the boot lid of taxis which presents a relatively large flat surface visible from the rear of the taxi and capable of bearing advertising material. Rooftop mounted advertising displays are however also available.

Safety legislation which has come into force relatively recently requires that appropriate apparatus be carried in taxis in order to seat and restrain babies and infants. Infant seats and restraint systems are however very bulky and present taxi owners with serious problems insofar as carrying a child seat in a taxi either seriously reduces the passenger carrying capacity of the taxi in respect of persons other than infants or alternatively seriously reduces the luggage carrying capacity of the taxi.

Luggage carrying capacity is of course of paramount importance when the taxi is required to work areas such as airports, train stations and bus stations where passengers are typically accompanied by voluminous luggage.

It is accordingly an object of the present invention to provide an advertising display device for a motor vehicle which augments the luggage carrying capacity of the vehicle.

According to the present invention there is provided a rooftop mounted advertising device for a motor vehicle comprising a luggage compartment having the capacity to contain at least a baby seat measuring in excess of 500 mm by 250 mm by 300 mm; advertising display panels incorporated in the advertising device having a substantial vertical profile when viewed from either side or the rear of the device; illumination means for the advertising display panels being protected from impact with articles in the luggage compartment; an access door to the luggage compartment adapted to provide ready access to the luggage compartment without removal of the compartment from its rooftop position.

One embodiment of the present invention will now be described with reference to the accompanying drawings in which:

FIG. 1 is a perspective view of an advertising device in accordance with the present invention;

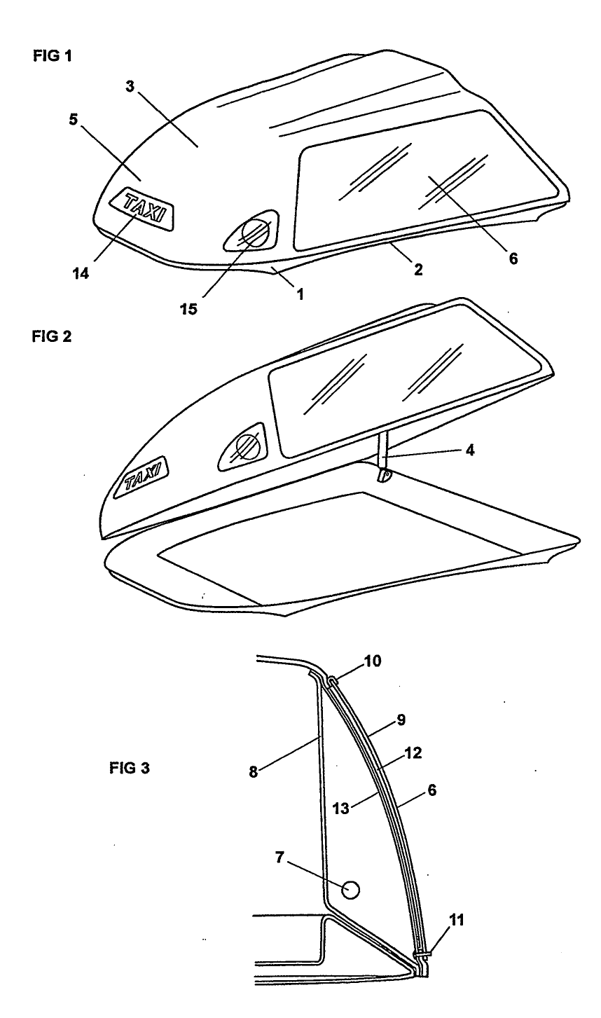

FIG. 2 is a perspective view of the advertising device of FIG. 1 in the open position;

FIG. 3 is a part transverse section through the advertising device of FIGS. 1 and 2 and;

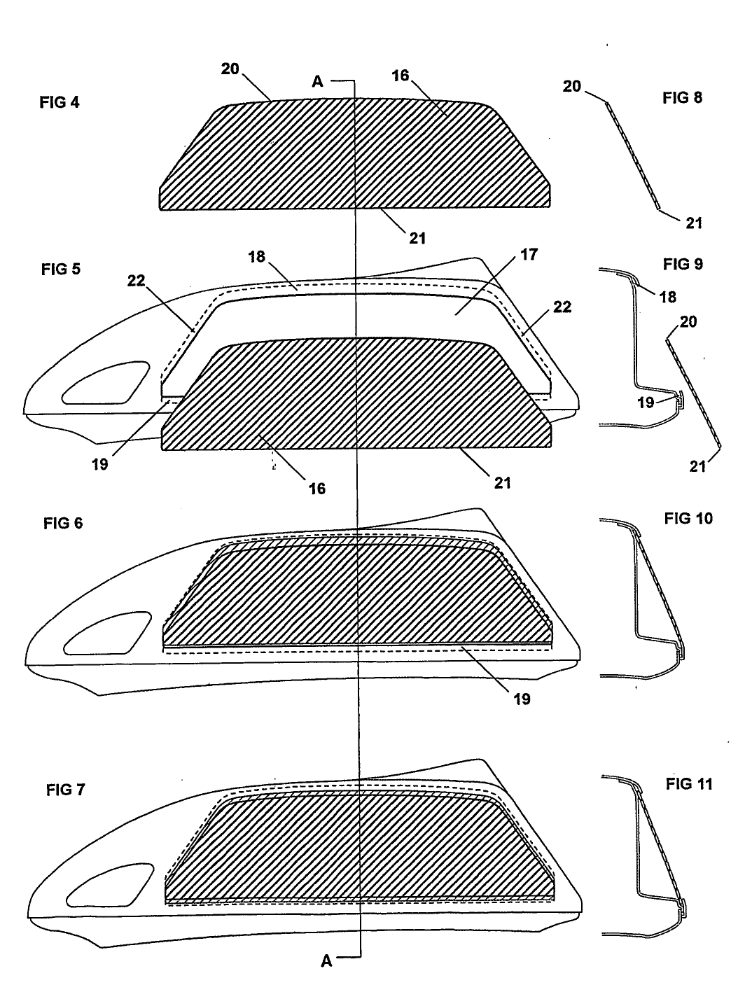

FIGS. 4-7 are side elevations of an advertising display panel being progressively installed in the advertising device depicted in FIG. 1-3.

FIGS. 8-11 are transverse cross sectional views through A-A′ of the articles depicted in FIGS. 4-7 respectively.

According to the embodiment of FIG. 1 there is disclosed an advertising device having a base 1 with a lower contour 2 shaped so as to conform to the profile of the roof of a motor vehicle. The base 1 co-operates with a lid 3 so that together they define a luggage compartment therebetween of adequate dimension to contain a child safety seat or other luggage. In this embodiment the base 1 is hingedly attached to lid 3 in order that ready access be provided to the luggage compartment therebetween. There is also provided a gas strut 4 adapted to bias the base and lid to an open position as is depicted in FIG. 2 when the two components are not latched together.

The luggage compartment is substantially rectangular cubic in shape and having the capacity to hold a baby seat having overall dimensions of 600 mm by 350 mm by 400 mm.

It will be appreciated that the lid 3 of the advertising device is shaped so as to have an aerodynamic front profile at 5 with a relatively flat advertising display 6 on either side. The display areas 6 present relatively large profiles when viewed in a side elevation for the display of advertising material. A like display panel is provided in the rear (not shown) of the unit for advertising display purposes.

As is best viewed from FIG. 3 the advertising display panels 6 may be backlit by fluorescent lighting 7 contained within lid 3 and protected from the luggage carrying area by a light box cover or bulkhead 8. It is of course important that shifting of luggage contained within the device due to cornering, braking or other forces generated by the motor vehicle when it is in motion do not allow the cargo to damage any part of the lighting or advertising.

In addition to fluorescent lighting tubes 7 the advertising device may also incorporate other lighting and panels such as an illuminated “taxi” sign 14 such as is normally present atop taxis and a spotlight 15 as is often utilised by taxis to assist in identifying street numbers.

It will be appreciated that a device in accordance with the present invention augments the luggage carrying capacity of a taxi while providing substantial advertising display visible from either side of the taxi or from the rear.

The system of affixation of translucent advertising display panels to the advertising device of the present invention is also unique and is designed to overcome difficulties with existing methods of affixation. Advertising display panels need to be changed from time to time as the advertisers finish their advertising programmes and new advertisers take their place. This change in signage can be a very time consuming exercise as hundreds of vehicles can be involved. Simple systems such as the use of self adhesive backed vinyl signs are for example inappropriate as they are hard to apply neatly without wrinkles and tend to weather and curl up at the edges. Such vinyl signage is also difficult to remove without leaving glue or gum deposits and the removal of the deposits can scratch the translucent window upon which they need to be mounted therefore effecting the light transmission qualities of the window. Other affixation methods for signage such as the inclusion of tracks or slide-in pockets on the external face of the advertising device are unsightly and require locking means. Accordingly a unique system has been developed for affixation of signage to advertising devices in accordance with the present invention.

According to the system which is depicted with reference to FIGS. 4-11 inclusive a translucent advertising panel 16 having significant form stability such as a 2 mm thick thermoplastic panel is inserted into an aperture 17 in the side of the advertising device which aperture has a shape substantially conforming to that of the panel but being marginally shorter in height at each corresponding position along its length than the height of the corresponding position along the length of the panel 16.

The aperture 17 in the advertising device is provided on its internal surface with a downwardly facing clip or channel 18 adjacent its upper edge and an upwardly facing clip or channel 19 on its internal lower face; the clips or channels being dimensioned so as to snugly receive the upper 20 and lower 21 edges respectively of the advertising panel 16 with the depth of the upper clip or channel 18 exceeding that of the lower clip or channel 19 such that when the upper edge of the advertising panel is introduced from the outside of the advertising device substantially fully into the upper clip or channel 18 the lower edge 21 of the panel 16 clears the outside lower edge of the aperture in the advertising device thereby permitting the lower edge 21 of the advertising panel 16 to be introduced into the lower clip or channel 19.

The depth of the lower clip or channel 19 is less than that of the upper clip or channel (preferably by about 50%) so that when the advertising panel rests in the bottom of the lower clip or channel 19 the upper edge 20 of the advertising panel still lies captivated within the upper clip or channel and within the upper edge of the aperture 17 within the advertising device. In this embodiment a channel is employed rather than a clip and furthermore the upper channel 18 extends down into side channels 22.

It will also be noted that the shape of the advertising panel 16 and correspondingly shaped aperture 17 in the side of the advertising device is such that the length as measured from side channel 22 to opposing side channel 22 decreases from the bottom 21 to top 22. By choosing an advertising panel of such shape it is ensured that as the advertising panel is slipped into the advertising device from bottom to top the sides of the advertising panel will engage with the side tracks 22 despite the fact that the advertising panel is in being introduced into the advertising device from the outside.

If the sides of the advertising panel are for example vertical and parallel then in order for the panel to engage the side tracks laterally extending slots (not shown) would have to be provided in the outside surface of the sides of the aperture 17 to facilitate introduction of the panel into the side tracks 22 as the panel is necessarily longer than the corresponding aperture 17 in the advertising device at any given point along its height in order that it engage the track and be maintained within the advertising device by the side tracks 22.

It has been found that advertising panels in accordance with the present invention as above described may be very quickly introduced and removed from advertising devices in accordance with the present invention utilising readily available glass handling suction cups without risk of damage to the advertising panels

It should be appreciated that alternative embodiments of the present invention may be devised apart from that above described. For example as an alternative to a horizontal split between the base and lid access panels may be provided at alternative locations such as a rear access door.

Furthermore the device may be configured to so as to attach to roof racks rather than directly to the roof of the vehicle. It is essential however that the advertising panels and associated lighting be protected from damage due to shifting of the cargo and that the cargo carrying capacity is at least adequate to contain a child seat, the average dimensions of which are 650 mm by 390 mm by 420 mm.

1. A rooftop mounted advertising device for a motor vehicle comprising a luggage compartment having the capacity to contain at least a baby seat measuring in excess of 500 mm by 250 mm by 300 mm; advertising display panels incorporated in the advertising device having a substantial vertical profile when viewed from either side or the rear of the device; illumination means for the advertising display panels being protected from impact with articles in the luggage compartment; an access door to the luggage compartment adapted to provide ready access to the luggage compartment without removal of the compartment from its rooftop position.

2. A rooftop mounted advertising device for a motor vehicle in accordance with claim 1 wherein the luggage compartment has the capacity to contain a baby seat having dimensions in excess of 600 mm by 350 mm by 400 mm.

3. A rooftop mounted advertising device for a motor vehicle in accordance with claim 1 wherein the advertising display panels are translucent.

4. A rooftop mounted advertising device for a motor vehicle in accordance with claim 1 wherein the advertising display panels are fabricated from thermoplastic material.

5. A rooftop mounted advertising device for a motor vehicle in accordance with claim 1 adapted to have an advertising panel with significant form stability inserted into an aperture in the side thereof such aperture having a shape substantially conforming to that of the panel but being marginally shorter in height at each corresponding position along its length than the height of the corresponding position along the length of the panel; the aperture in the advertising device being provided on its internal surface with a downwardly facing clip or channel adjacent its upper edge and an upwardly facing clip or channel on its internal lower face; the clips or channels being dimensioned so as to snugly receive the upper and lower edges respectively of the advertising panel with the depth of the upper clip or channel exceeding that of the lower clip or channel such that when the upper edge of the advertising panel is introduced from the outside of the advertising device substantially fully into the upper clip or channel the lower edge of the panel clears the outside lower edge of the aperture in the advertising device thereby permitting the lower edge of the advertising panel to be introduced into the lower clip or channel; the depth of the lower clip or channel being less than that of the upper clip or channel so that when the advertising panel rests in the bottom of the lower clip or channel the upper edge of the advertising panel still lies captivated within the upper clip or channel and within the upper edge of the aperture in the advertising device.

6. A rooftop mounted advertising device for a motor vehicle in accordance with claim 1 adapted to have an advertising panel with significant form stability inserted into an aperture in the side thereof such aperture having a shape substantially conforming to that of the panel but being marginally shorter in height at each corresponding position along its length than the height of the corresponding position along the length of the panel; the shape of the advertising panel and correspondingly shaped aperture in the side of the advertising device being such that the length decreases from the bottom to top; the aperture in the advertising device being provided on its internal surface with a downwardly facing clip or channel adjacent its upper edge and an upwardly facing clip or channel on its internal lower face; the clips or channels being dimensioned so as to snugly receive the upper and lower edges respectively of the advertising panel with the depth of the upper clip or channel exceeding that of the lower clip or channel such that when the upper edge of the advertising panel is introduced from the outside of the advertising device substantially fully into the upper clip or channel the lower edge of the panel clears the outside lower edge of the aperture in the advertising device thereby permitting the lower edge of the advertising panel to be introduced into the lower clip or channel; the depth of the lower clip or channel being less than that of the upper clip or channel so that when the advertising panel rests in the bottom of the lower clip or channel the upper edge of the advertising panel still lies captivated within the upper clip or channel and within the upper edge of the aperture in the advertising device.

7. A rooftop mounted advertising device for a motor vehicle in accordance with claim 1 adapted to have an advertising panel with significant form stability inserted into an aperture in the side thereof such aperture having a shape substantially conforming to that of the panel but being marginally shorter in height at each corresponding position along its length than the height of the corresponding position along the length of the panel; the aperture in the advertising device being provided on its internal surface with a downwardly facing clip or channel adjacent its upper edge and an upwardly facing clip or channel on its internal lower face; the clips or channels being dimensioned so as to snugly receive the upper and lower edges respectively of the advertising panel with the depth of the upper clip or channel exceeding that of the lower clip or channel such that when the upper edge of the advertising panel is introduced from the outside of the advertising device substantially fully into the upper clip or channel the lower edge of the panel clears the outside lower edge of the aperture in the advertising device thereby permitting the lower edge of the advertising panel to be introduced into the lower clip or channel; the depth of the lower clip or channel being less than that of the upper clip or channel so that when the advertising panel rests in the bottom of the lower clip or channel the upper edge of the advertising panel still lies captivated within the upper clip or channel and within the upper edge of the aperture in the advertising device; the access door of the advertising device comprising a lid hingedly attached to a base in order that ready access be provided to the luggage compartment therebetween; the advertising display panels being attached to the lid.

8. A rooftop mounted advertising device for a motor vehicle in accordance with claim 1 adapted to have an advertising panel with significant form stability inserted into an aperture in the side thereof such aperture having a shape substantially conforming to that of the panel but being marginally shorter in height at each corresponding position along its length than the height of the corresponding position along the length of the panel; the aperture in the advertising device being provided on its internal surface with a downwardly facing clip or channel adjacent its upper edge and an upwardly facing clip or channel on its internal lower face; the clips or channels being dimensioned so as to snugly receive the upper and lower edges respectively of the advertising panel with the depth of the upper clip or channel exceeding that of the lower clip or channel such that when the upper edge of the advertising panel is introduced from the outside of the advertising device substantially fully into the upper clip or channel the lower edge of the panel clears the outside lower edge of the aperture in the advertising device thereby permitting the lower edge of the advertising panel to be introduced into the lower clip or channel; the depth of the lower clip or channel being less than that of the upper clip or channel so that when the advertising panel rests in the bottom of the lower clip or channel the upper edge of the advertising panel still lies captivated within the upper clip or channel and within the upper edge of the aperture in the advertising device; the access door of the advertising device comprising a lid hingedly attached to a base in order that ready access be provided to the luggage compartment therebetween; a strut adapted to bias the base and lid to an open position when the two components are not latched together; the advertising display panels being attached to the lid.

9. A rooftop mounted advertising device for a motor vehicle in accordance with claim 1 adapted to have an advertising panel with significant form stability inserted into an aperture in the side thereof such aperture having a shape substantially conforming to that of the panel but being marginally shorter in height at each corresponding position along its length than the height of the corresponding position along the length of the panel; the aperture in the advertising device being provided on its internal surface with a downwardly facing clip or channel adjacent its upper edge and an upwardly facing clip or channel on its internal lower face; the clips or channels being dimensioned so as to snugly receive the upper and lower edges respectively of the advertising panel with the depth of the upper clip or channel exceeding that of the lower clip or channel such that when the upper edge of the advertising panel is introduced from the outside of the advertising device substantially fully into the upper clip or channel the lower edge of the panel clears the outside lower edge of the aperture in the advertising device thereby permitting the lower edge of the advertising panel to be introduced into the lower clip or channel; the depth of the lower clip or channel being less than that of the upper clip or channel so that when the advertising panel rests in the bottom of the lower clip or channel the upper edge of the advertising panel still lies captivated within the upper clip or channel and within the upper edge of the aperture in the advertising device; the access door of the advertising device comprising a lid hingedly attached to a base in order that ready access be provided to the luggage compartment therebetween; a gas strut adapted to bias the base and lid to an open position when the two components are not latched together; the advertising display panels being attached to the lid.

10. A rooftop mounted advertising device for a motor vehicle in accordance with claim 1 wherein the access door of the advertising device comprises a lid hingedly attached to a base in order that ready access be provided to the luggage compartment therebetween; all attachment means necessary to facilitate attachment of the advertising device to a vehicle being directly or indirectly affixed to the base rather than the lid and all illumination, electrical and electronic parts being directly or indirectly affixed to the lid rather than the base; the hinges and any other connections between lid and base being of a quick release variety such that the lid may be readily removed for servicing.

11. A rooftop mounted advertising device for a motor vehicle in accordance with claim 1 wherein the access door of the advertising device comprises a lid hingedly attached to a base in order that ready access be provided to the luggage compartment therebetween; all attachment means necessary to facilitate attachment of the advertising device to a vehicle being directly or indirectly affixed to the base rather than the lid and all illumination, electrical and electronic parts as well as advertising panels being directly or indirectly affixed to the lid rather than the base; the hinges and any other connections between lid and base being of a quick release of a variety such that the lid may be readily removed for servicing.
